(19) United States
(12) Patent Application Publication
(10) Pub. No.: US 2007/0058543 A1
(43) Pub. Date: Mar. 15, 2007

(54) ATM over ethernet scheduler

(75) Inventors: Jean-Marc Fenart, Montigny Le Bretonneux (FR); Patrick LaGrange, Paris (FR)

Correspondence Address: TROP PRUNER & HU, PC, 1616 S. VOSS ROAD, SUITE 750, HOUSTON, TX, 77057-2631, US

(73) Assignee: Nortel Networks Limited, St. Laurent (CA)

(21) Appl. No.: 11/270,319

(22) Filed: Nov. 9, 2005

(30) Foreign Application Priority Data
Nov. 9, 2004 (GB) GB 0424704.5

(51) Int. Cl. H04L 12/26

(52) U.S. Cl. 370/230; 370/389

(57) ABSTRACT

A method and apparatus is described for encapsulating data from a cell and packet based network utilizing a virtual circuit type implementation mechanism and an asynchronous transfer format such as ATM in a frame of a frame based protocol such as Ethernet. At least two policies are provided for scheduling the encapsulation of the data. One of the at least two policies is selected for encapsulating the data.

### FIELD OF THE INVENTION

The present invention relates to techniques and apparatus for transmitting data from a cell and packet based network utilizing a virtual circuit type implementation mechanism and an asynchronous transfer format such as the ATM format from a sending unit to a receiving unit over a frame based communication link such as an Ethernet communication link.

### BACKGROUND OF THE INVENTION

The invention is described hereinafter in its non-limiting application to a UMTS network in Frequency Division Duplex (FDD) mode, and FIG. 1 shows the architecture of such a network which can be used with the present invention.

The mobile service switches 10, belonging to a Core Network (CN), are linked to one or more fixed networks 11 and, by means of an interface called lu, to control units 12, or RNCs (Radio Network Controllers). Each RNC 12 is linked to one or more radio stations 13 by means of an interface called lub. The radio stations 13, distributed over the network coverage area, can communicate by radio with mobile terminals 14, 14a and 14b, called UEs (User Equipment). The radio stations can be grouped together to form nodes called “Nodes B”. Some RNCs 12 can additionally communicate with each other by means of an interface called lur. The RNCs and the radio stations form an access network called UTRAN (UMTS Terrestrial Radio Access Network).

The UTRAN includes elements from layers 1 and 2 of the ISO model with a view to providing the links required on the radio interface (called Uu), and a Radio Resource Control (RRC) stage 15A belonging to layer 3, as described in the technical specification 3G TS 25.301, “Radio Interface Protocol Architecture”, version 4.2.0 published in December 2001 by the 3GPP.

FIG. 2 shows the RRC stages 15A, 15B and the stages of the lower layers that belong to the UTRAN and to a UE. On each side, layer 2 is subdivided into a Radio Link Control (RLC) stage 16A, 16B and a Medium Access Control (MAC) stage 17A, 17B. Layer 1 includes a coding and multiplexing stage 18A, 18B. A radio stage 19A, 19B provides for the transmission of radio signals based on symbol trains supplied by stage 18A, 18B, and provides for the reception of signals in the other direction.

There are various ways of adapting the protocol architecture according to FIG. 2 to the UTRAN hardware architecture according to FIG. 1, and in general various structures can be adopted according to the channel types (see section 11.2 of the technical specification 3G TS 25.401, “UTRAN Overall Description”, version 4.2.0 published in September 2001 by the 3GPP). The RRC, RLC and MAC stages are in the RNC 12. Layer 1 is for example in the Node B. Part of this layer may however be in the RNC 12.

Layers 1 and 2 are each controlled by the RRC sub-layer, the characteristics of which are described in the technical specification 3G TS 25.331, “RRC Protocol Specification”, version 4.1.0 published in June 2001 by the 3GPP. The RRC stage 15A, 15B supervises the radio interface. It additionally handles flows to be transmitted to the remote station according to a “control plane”, as opposed to the “user plane” which corresponds to the handling of user data coming from layer 3. UMTS in FDD (Frequency Division Duplex) mode supports a macrodiversity technique which involves anticipating that a UE can communicate simultaneously with separate radio stations in an active set such that, in the downlink direction, the UE receives the same information several times and that, in the uplink direction, the radio signal transmitted by the UE is picked up by the radio station to form various estimations which are then combined in the UTRAN. Macrodiversity results in a receive gain which improves the performance of the system owing to the combination of different observations of the same item of information. It also enables Soft Handovers (SHOs) to be achieved as the UE moves.

In macrodiversity, branching of transport channels for multiple transmission from the UTRAN or the UE and the combination of these transport channels in receive mode are operations for which a selection and combination module belonging to layer 1 is responsible. This module is at the interface with the MAC sub-layer, and it is located in the RNC serving the UE. If the radio stations involved depend on different RNCs communicating over the lur interface, one of these RNCs acts as SRNC and the other as DRNC.

When several RNCs are involved in a communication with a UE, there is generally one Serving RNC (SRNC), in which the layer-2-based modules (RLC and MAC) are located, and at least one Drift RNC (DRNC) to which a radio station is linked, and with which radio station the UE is in radio communication. Suitable protocols provide the exchanges between these RNCs over the lur interface, for example ATM (Asynchronous Transfer Mode) and AAL2 (ATM Adaptation Layer No. 2).

These same protocols can also be employed on the lub interface for exchanges between a Node B and its RNC. Above the ATM and AAL2 layers, a Frame Protocol (FP) is used in the user plane to enable the SRNC to communicate with the Node B or Nodes B involved in a communication with a given UE.

The networks in which the UTRAN lub employs ATM are usually based on a Time Division Multiplex (E1, DS1 . . . ) or a Synchronous Digital Hierarchy (SDH) (SDH being the optical transport layer in wide area networks) physical layer. ATM has been selected so far as it provides a mature technology in term of multi-service and Quality Of Service (QoS) management, which are strong requirements of UTRAN transmission. Typically, in a network in which the UTRAN lub employs ATM, several kinds of ATM traffic are exchanged between a RNC and the managed Node-Bs. This is illustrated on FIG. 3, which also shows that lub transports multiple different data streams with different requirements in terms of quality of service (Unspecified Bit Rate for best effort, Variable Bit Rate—Real Time, Constant Bit Rate). This is perfectly managed by ATM networks of which QoS and bandwidth management is part of the definition.

Nowadays, coming with the ubiquity of the Internet and the convergence of the telecommunications and data communication worlds, Ethernet MAN networks (Metropolitan Access Networks) are starting to appear as a cost effective solution as compared to previous ATM based networks. This is furthermore of interest as Ethernet is also available in the last mile, i.e. up to the node-B premise (e.g. through VDSL lines or fiber). Ethernet is specified in the set of IEEE 802 standards published by the Institute of Electrical and Electronics Engineers (IEEE).

The CIF (Cells in Frames) Alliance has specified a protocol which allows ATM cells to be embedded into various frame based legacy protocols, e.g. Ethernet and Token Ring. Only one ATM header is used for up to 31 cells from the same virtual circuit in a packet.

U.S. Pat. No. 6,728,261 describes a method of encapsulating an ATM cell in a UDP/IP datagram and then placing this in an Ethernet frame. However the method does not provide for alternative policies or for the maintenance of the QoS of the ATM network.

### SUMMARY OF THE INVENTION

An object of the present invention is to provide methods and apparatus to provide a service for the transport of data from cell and packet based networks utilizing a virtual circuit type implementation mechanism and an asynchronous transfer format such as ATM over a frame based link such as an Ethernet link.

An advantage of the present invention is that the methods and apparatus preserve the intrinsic capabilities of the cell and packet based network in terms of addressing, quality of service and/or network management. Another advantage is that the present invention allows the transport of data from cell and packet based networks utilizing a virtual circuit type implementation mechanism and an asynchronous transfer format such as ATM over a frame based link, such as Ethernet, on the UTRAN lub interface as well as complying to the specific UTRAN lub requirements, in particular with regard to the QoS. A further advantage of the present invention is that the quality of service information conveyed by the cell and packet based network utilizing a virtual circuit type implementation mechanism and an asynchronous transfer format such as ATM is also preserved.

According to one broad aspect, the invention provides a method for encapsulating data from a cell and packet based network utilizing a virtual circuit type implementation mechanism and an asynchronous transfer format such as ATM in a frame of a frame based protocol such as an Ethernet frame. A further advantage of the present invention is that no interworking of protocols is required. Hence, existing protocols are used and adapted to provide the services required without requiring major investments in new protocols or devices.

In another aspect the present invention provides a method and apparatus for encapsulating data from a cell and packet based network utilizing a virtual circuit type implementation mechanism and an asynchronous transfer format in a frame of a frame based protocol, the method or apparatus being adapted to provide at least one policy and more preferably at least two policies for scheduling the encapsulation of the data. One of the at least two policies is then selected for encapsulating the data.

In one embodiment, the data from a cell and packet based network utilizing a virtual circuit type implementation mechanism and an asynchronous transfer format such as ATM data is encapsulated using a first connectionless datagram forwarding protocol and then using the frame based protocol, e.g. in a UDP/IP/Ethernet frame.

According to one broad aspect, the invention provides a method for scheduling data from a cell and packet based network utilizing a virtual circuit type implementation mechanism and an asynchronous transfer format such as ATM data over frames of a frame based protocol such as Ethernet frames based on Quality of Service information.

According to another broad aspect, the invention provides a method for scheduling data from a cell and packet based network utilizing a virtual circuit type implementation mechanism and an asynchronous transfer format such as ATM data over frames of a frame based protocol such as Ethernet frames based on addressing information. In a preferred embodiment, the scheduling of data from a cell and packet based network utilizing a virtual circuit type implementation mechanism and an asynchronous transfer format such as ATM data is performed based on virtual channel identifiers.

According to yet another broad aspect, the invention provides a method for scheduling data from a cell and packet based network utilizing a virtual circuit type implementation mechanism and an asynchronous transfer format such as ATM data over frames of a frame based protocol such as Ethernet frames based on data type information.

In a preferred embodiment, the scheduling of data from a cell and packet based network utilizing a virtual circuit type implementation mechanism and an asynchronous transfer format such as ATM data is performed based on the adaptation layer type of the data, e.g. the AAL type of the ATM data.

The present invention also provides a scheduler which is able to carry out any of the methods of the present invention. The scheduler may be included in a node of a network, e.g. a wireless network. The node may be a wireless access point of a wireless telecommunications system such as a base station or “Node B”, for example.

The present invention also provides software which when executed on a processing engine executes any of the methods of the present invention. The software programs may be stored on any suitable machine readable medium such as magnetic disks, diskettes, solid state memory, tape memory, optical disks such as CD-ROM or DVD-ROM, etc.

The present invention is also notable for being characterized by the signals transmitted which comprise data from a cell and packet based network utilizing a virtual circuit type implementation mechanism and an asynchronous transfer format encapsulated in a frame of a frame based protocol, a header of the frame being populated with QoS information associated with the cells. The data can be encapsulated in a connectionless datagram forwarding protocol and then using the frame based protocol, a header of the connectionless datagram forwarding protocol being populated with QoS information associated with the cells. The QoS information is used by the network in which the signal is present for determining QoS performance, e.g. allowed delay and/or bit rate of the signal.

The present invention will now be described with reference to the following drawings. The drawings are schematic only.

### BRIEF DESCRIPTION OF THE DRAWINGS

FIG. 1 shows a wireless telecommunications network in FDD mode with which the present invention can be used.

FIG. 2 shows radio resource control stages of the lower layers that belong to the network (UTRAN) and to the user (UE) for a network of the kind shown in FIG. 1.

FIG. 3 shows that transport across an interface in a network such as shown in FIG. 1 requires multiple different data streams with different requirements in terms of quality of service (Unspecified Bit Rate for best effort, Variable Bit Rate—Real Time, Constant Bit Rate).

FIGS. 4 and 5 show network configurations which can be used with the present invention, each being an embodiment of the present invention.

FIG. 6 show an embodiment of a scheduler in accordance with the present invention.

FIGS. 7 and 8 show how a frame can be built up in accordance with embodiments of the present invention using either ATM cells encapsulated in both IP/UDP and an Ethernet frame or directly in an Etherent frame respectively.

FIGS. 9 to 13 show further embodiments of a scheduler in accordance with the present invention.

FIG. 14 show a schematic implementation of a scheduler according to an embodiment of the present invention.

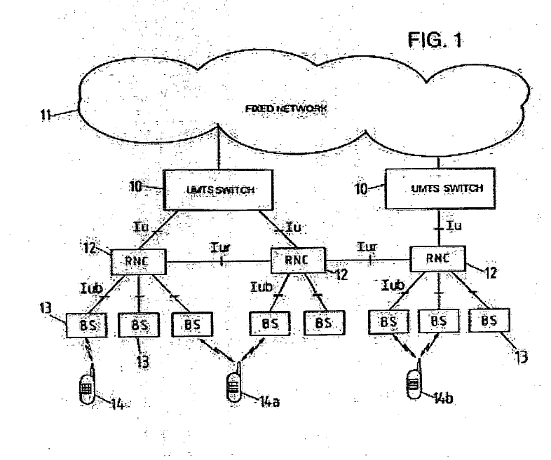

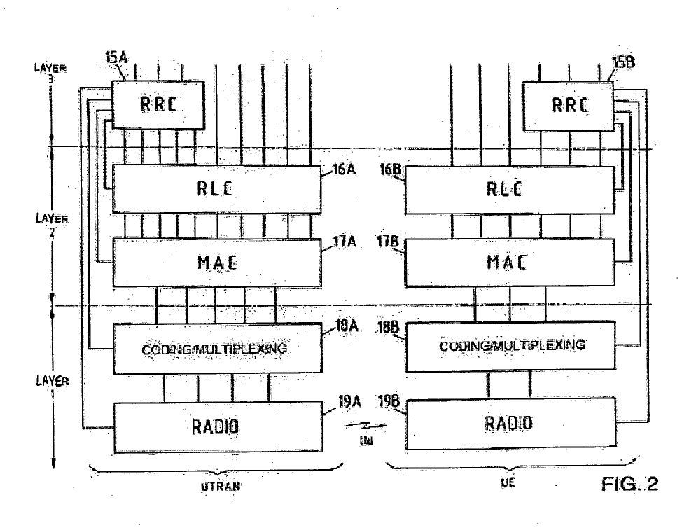

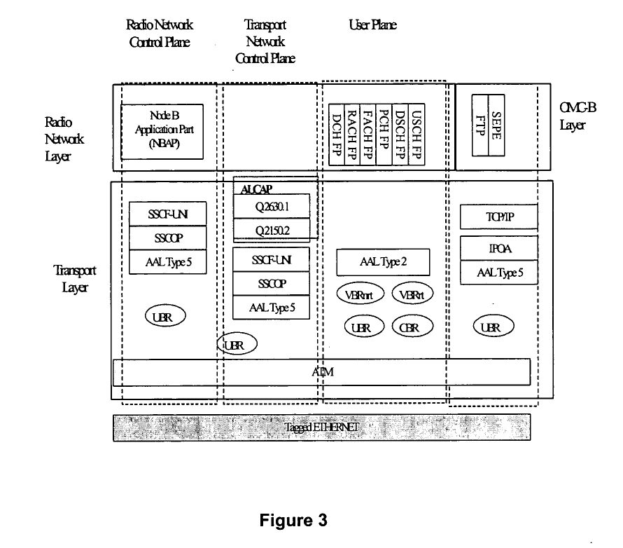

### 1 DETAILED DESCRIPTION OF THE PREFERRED EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The present invention will also be described with reference to a scheduler for scheduling the encapsulation of data cells into a frame of a frame based protocol. However the present invention is not limited thereto and schedulers according to the present invention can also perform the inverse action of receiving data encapsulated in a frame of a frame based protocol and then stripping the data cells out of this received information and forwarding them.

In the present description, the invention will be described more particularly in its application, non limiting, to third generation radio communication networks of the UMTS (“Universal Mobile Telecommunication System”) type third generation cellular networks standardized by the organization 3GPP (3rd Generation Partnership Project).

The target platform for such a network is based on a cell and packet based network utilizing a virtual circuit type implementation mechanism and asynchronous transfer such as ATM (Asynchronous Transfer Mode). The present invention will mainly be described with reference to an ATM communications platform although it may be extended to other cell and packet based communication infrastructures. Like any other such technology operating at the Data Link Layer, ATM is independent of upper layer protocols. This means that ATM will carry any Protocol Data Unit (PDU) that is handed down to it, e.g. through an ATM Service Access Point (SAP).

ATM includes ATM Adaptation Layers (AALs), which reside above the basic ATM Layer and below the Network Layer, to accommodate internetworking functions. The ATM adaption layers are a collection of standardized protocols that provide services to higher layers by adapting user traffic to a cell format. The AAL is divided into the convergence sublayer (CS) and the segmentation and reassemble (SAR) sublayer. The AAL types currently defined are:
AAL1 is a protocol standard used for the transport of constant bit rate (CBR) traffic (i.e., audio and video) and for emulating TDM-based circuits (i.e., DS 1, El, etc.).
AAL2 is a protocol standard for supporting time-dependent variable bit rate (VBRRT) connection-oriented traffic (i.e., packetized video and audio).
AAL types 3 and 4 provide a protocol standard for supporting both connectionless and connection-oriented variable bitrate (VBR) traffic. This AAL is also used to support SMDS (switched multimegabit digital service).
AAL type 5 is a protocol standard for supporting the transport of lightweight variable bit rate (VBR) traffic and signaling messages. This AAL is also used to support frame relay services.

Quality of service is a term which refers, for example, to a set of ATM performance parameters that characterize the traffic over a given virtual connection (VC). These parameters include the CLR (cell loss ratio), CER (cell error rate), CMR (cell misinsertion rate), CDV (cell delay variation), CTD (cell transfer delay), and the average cell transfer delay. Five service classes have been defined by the ATM Forum in terms of QoS parameters. There is a correlation between these classes and the ATM Adaption Layers defined above. The QoS service classes are:
Class 0—best efforts service
Class 1 specifies the parameters for circuit emulation. It is associated with AAL1
Class 2 specifies the parameters for VBR audio & video. It is associated with AAL2
Class 3 specifies the parameters for connection-oriented services. It is associated with AAL3/4 and AAL5
Class 4 specifies the parameters for connectionless data transfer. It is associated with AAL3/4 and AAL5

The present invention can also make use of a connectionless datagram type of forwarding mechanism, e.g. like provided by the Internet Protocol (IP). IP provides a best effort packet delivery system. The basic PDU is a datagram. The header includes a service type field which determines the datagram precedence, e.g. low delay, high throughput, high reliability. Hence IP allows some QoS to be defined. Also the header includes an IP source and destination address. Two architectures have been proposed for providing guaranteed QoS via IP: integrated services and differentiated services also known as diff-serv—see RFC 1633 June 1994 and RFC 2475, December 1998, respectively. Diff-serv allows IP traffic to be grouped into classes based on, for example, delay or priority. Information with respect to service class is contained in the header.

The present invention can also make use of a transport protocol that makes use of the connectionless datagram forwarding service of the connectionless datagram type router based mechanism, e.g. like TCP, UDP or Real Time Transport Protocol in combination with IP.

TCP provides a stream delivery service. The basic PDU is a segment. TCP headers define source and destination ports. TCP provides an acknowledgement mechanism for data segments. The acknowledgement mechanism can delay real time traffic, e.g. for voice. Accordingly, TCP is less preferred for use in the present invention.

UDP is a connectionless datagram forwarding mechanism that does not provide a reliable service, i.e. it does not have an acknowledgement mechanism. This allows a fast transport of packets which is a requirement for transmission of voice packets. A protocol such as UDP, which does not have an acknowledgment mechanism, is preferred.

In the following reference will be made mainly to ATM, UDP, IP and Ethernet for ease of description but the present invention is not limited thereto.

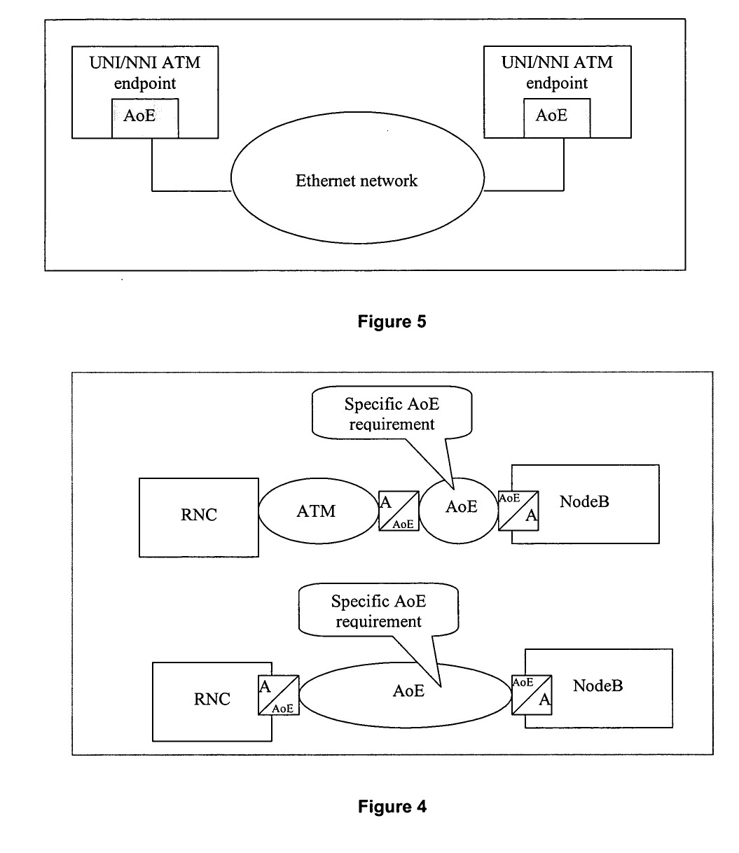

FIG. 4 illustrates the specific requirements of data transmission in a UTRAN: in the upper part of the figure is shown an RNC connected to a Node B through an ATM network and, advantageously, an Ethernet network. The ATM data is processed by an ATM/ATM-over-Ethernet interface module (AoE module) in order to be transported over the Ethernet network towards the Node-B. The AoE module provides an adaption function between ATM and Ethernet. When reaching the Node-B, the transported data is processed by an ATM-over-Ethernet interface module (AoE module) which provides the Node-B with the ATM data in a transparent way. This AoE module also provides an adaption function.

In the lower part of the figure are shown a RNC and a Node-B connected via an Ethernet network. Each of these two network nodes interconnected to an Ethernet network are provided an ATM/ATM-over-Ethernet bilateral interface module in order to process the ATM data in a format suitable for transport over the Ethernet network, and vice-versa. These AoE modules also provide an adaption function.

Shown on FIG. 5 is a more generic topology of a network in which the present invention can be implemented. Two UNI/NNI ATM network nodes are linked by an Ethernet network. Each node provides an ATM-Ethernet an adaption function.

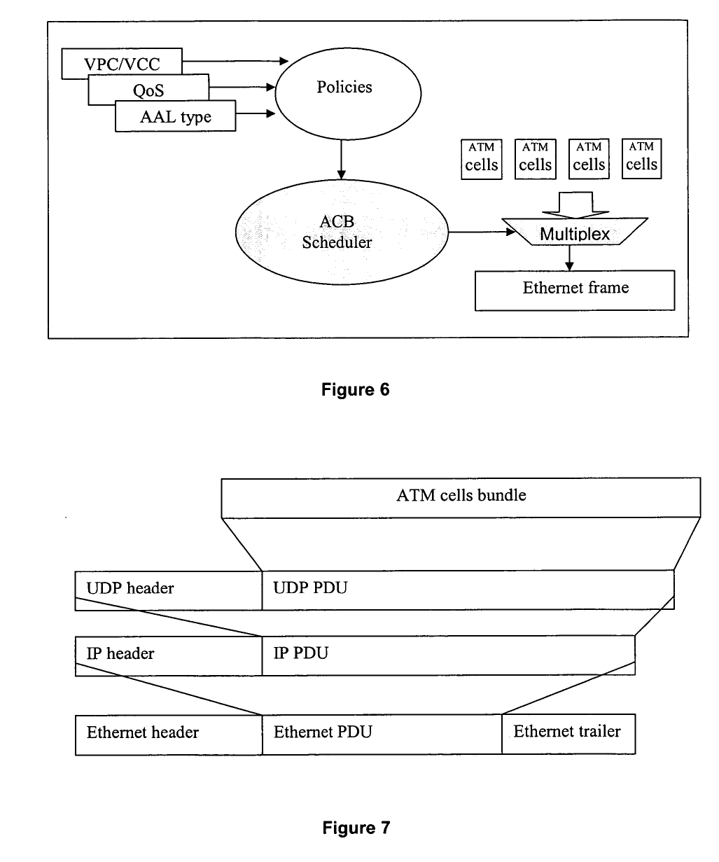

According to the invention, the framework of the ATM over Ethernet provided transport service (see FIG. 6) is based on a scheduler and scheduling policies. In particular in an embodiment of the present invention at least two scheduling policies are defined and a selection of one policy can be made, e.g. depending upon the application upon the nature of the network or other scheme. Preferably, three policies are defined and a selection of one of them is made. A cell bundle scheduler loads ATM cells into an Ethernet frame using a multiplexer to multiplex the ATM cells into the frame. How the cells and which cells are loaded into a frame is determined by a policy. In accordance with separate embodiments of the present invention, three different policies are respectively driven by: 1) addressing information, 2) Quality of Service information, or 3) data type information. The scheduler distributes the ATM cells over Ethernet frames according to these policies.

1.1 Encapsulation Principle

An ATM cell bundle (ACB) is an integer number of basic ATM cells sometimes called “ATM AAL0” cells (each 53 bytes). It is preferred if an ATM cell is not overlapped in different ACBs. The size of the ACB is in between 1 ATM cell and maximum allowed by the Ethernet MTU limitation (i.e. 15000 bytes for classical 100Base-Tx LAN). The number of cells in one ACB is derived from the UDP Packet Data Unit (PDU) length indication.

In some case ATM cells may be larger than the Ethernet MTU limitation. For example, AAL5 cells can be larger. In such a case it is necessary to segment such large frames. It is preferred if the segmentation of such frames is handled by the datagram protocol, e.g. IP. The IP protocol then arranges for the segments to be re-assembled.

No specific header needs to be added to an ACB. No FCS (Frame Correction Sequence) needs to be appended to an ACB. For example, protection can be provided by other layers, e.g. ATM HEC (Header Error Correction), UDP optional checksum, and Ethernet FCS.

In one embodiment of the present invention, data from a cell and packet based network utilizing a virtual circuit type implementation mechanism and an asynchronous transfer format such as ATM is encapsulated according to a connectionless datagram protocol (with or without an acknowledgement facility but preferably without) such as IP/TCP or IP/UDP and then in a frame of a frame based protocol such as an Ethernet frame. For example, ATM cells bundles are encapsulated over an Ethernet/IP/UDP link. The principle of encapsulating ATM cells bundle over an Ethernet/IP/UDP link is illustrated on FIG. 7. The UDP header hosts an ATM cell bundles encapsulation service identifier as a port number, and a preferably a unique UDP port number is defined and used for the ATM cell bundles encapsulation service. In the case of IP Version 4, the UDP checksum can be set to zero if other protocol layers such as Ethernet provide the requested data integrity check. The UDP payload hosts the ACB. The maximum size of the ACB fitting into the UDP payload is preferably calculated in such a way that the IP datagram is not fragmented on top of multiple Ethernet frames. If very large ATM cells are to be handles, e.g. from AAL5, then the IP protocol handles the segmentation and reassembly.

The ACB and its encapsulating UDP datagram can be transported over either IP Version 4 or IP Version 6. For IP Version 4, no specific information has to be hosted within the IP header for the present service (unless large ATM cells have to segmented). No specific option is required. Nevertheless, the IP header may host some QoS information for the ATM over Ethernet service according to the present invention. For IP Version 6, no specific information has to be hosted within the IP header for the present service (unless large ATM cells have to segmented). No specific option is required. Nevertheless, the IP header may host some QoS information for the ATM over Ethernet service according to the present invention.

The IP payload hosts the UDP datagram. The IP Version 4 datagram must not be fragmented (unless large ATM cells have to segmented).

IPsec authentication and encryption as per AH/ESP are applicable in such case of transmission of ACB over an IP/UDP/Ethernet link. Nevertheless its use is not mandatory.

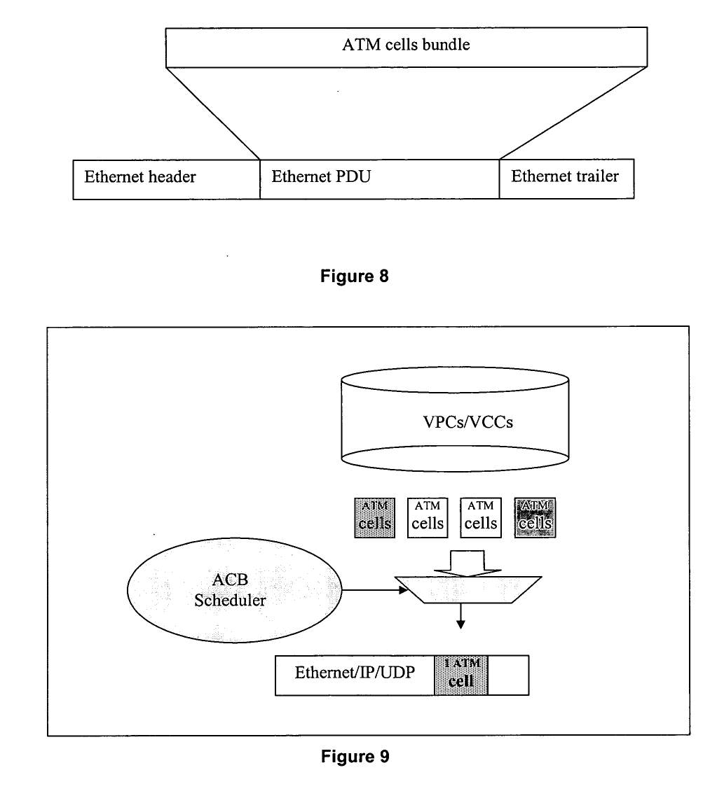

In one embodiment of the invention, data from a cell and packet based network utilizing a virtual circuit type implementation mechanism and an asynchronous transfer format such as ATM is encapsulated directly in a frame of a frame based protocol such as an Ethernet frame. For example, ATM cells bundles are directly encapsulated over an Ethernet link. The principle of directly encapsulating ATM cells bundle over an Ethernet link is illustrated on FIG. 8. The ATM cells bundle is encapsulated into the Ethernet packet data unit (PDU) or payload field.

An Ethernet Medium Access Control (MAC) frame is a data transmission unit on an Ethernet/IEEE 802 network that conveys protocol data units between two MAC layers. As specified in the IEEE standard 802.1Q approved in December 1998, Ethernet networks may support one or more Virtual Local Area Networks (VLANs). An Ethernet frame circulating in such a network may include, after the MAC address, an additional field called “TAG HEADER”, “TAG CONTROL INFORMATION”, or “Q-tag” which carries information related to the QoS of the transmission. The different Ethernet MAC formats are described in the IEEE 802.1 and IEEE 802.1Q standard specifications which describe QoS protocols at the MAC service level.

The ETHERTYPE can be set to, for ETHERTYPE_IP, 0x800 and for ETHERTYPE_ACB, a TBD value. In both Ethernet frame format, the “MAC CLIENT DATA” field hosts, either the IP datagram in the case of encapsulation of ATM cells bundles over an Ethernet/IP/UDP link, or the ACB packet data unit (PDU) in the case of direct encapsulation of ATM cell bundles over an Ethernet link.

1.2 Addressing

In the case of encapsulation of ATM cells bundles over an Ethernet/IP/UDP link, a UDP port number, preferably a dedicated port number, will be defined and used for the ATM data encapsulation service as mentioned above. For IP Version 4, an IP Version 4 address identifies the two endpoints of the service. There is no specific requirement on the IP address. The IP Version 4 address is a unicast address. For IP Version 6, the IP Version 6 address identifies the two endpoints of the service. There is no specific requirement on the IP address, which can be any valid addresses defined for IP Version 6 (for instance an IPv4 compatible address). The IP Version 6 address is a unicast address. There is no need for mapping between ATM addressing and Ethernet/IP/UDP addressing. Preferably, the Ethernet packet network is used as a point to point tunnel using only endpoints addresses (e.g. Ethernet/UDP/IP addresses).

The Ethernet address is of unicast type. Any valid unicast Ethernet address can be used. The ATM Virtual Path (VP) and Virtual Circuit (VC) can be used to identify flows. The VP and VC identifiers are hosted by the basic ATM cell header (sometimes known as the ATM AAL0 cell header). In the case of the embodiment using direct encapsulation of ATM cell bundles over an Ethernet link, an ETHERTYPE_ACB can be used to identify the service. 1.3 Scheduler Policies

The invention advantageously uses at least two policies and selects one during the encapsulation. For example, embodiments of the present invention advantageously use the Quality of Service information conveyed at the different layers of the encapsulation processes as described above. The ATM Forum has defined the following Quality of Service (QoS) classes: Unspecified Bit Rate (UBR), Constant Bit Rate (CBR), Variable Bit Rate (VBR), Variable Bit Rate—Real-Time (VBRrt). These different classes are mapped to an ATM connection identified by ATM virtual circuit identifier, i.e. a virtual path identifier and virtual channel identifier information. With regard to IP data, the DiffServ QoS protocol provides a DiffServ Control Point (DSCP) field which carries QoS related information. Lastly, as described previously, the QTagged Ethernet MAC frame contains an additional control information field, called “Qtag”, which carries information related to the QoS of the transmission. According to an aspect of the present invention, the QoS related information is relayed from one level of the encapsulation process to the other and exploited at the scheduling stage. This provides a process of transporting ATM data over an Ethernet link with a QoS level that applies to the Ethernet frames and corresponds to the QoS level required for the transported ATM data. The correspondence is managed through a mapping scheme, as described hereunder.

1.3.1 Transparent

1.3.1.1 One ATM Cell Per ACB

In this embodiment, the scheduler follows a very simple policy and maps exactly one ATM cell in every ACB. This policy is illustrated on FIG. 9. In this case the Ethernet Qtag field and IP Diffserv DSCP field are kept null. The ATM OAM cells are transmitted transparently as per this transparent policy. In this case the QoS tagging may be filled with a value different from null.

1.3.1.2 Several ATM Cells Per ACB

In this embodiment, the scheduler maps several ATM cells in every ACB. The number of cells in one Ethernet frame is driven by any of three parameters or any combination of these:
A fixed number of cells. The number of cells selected for encapsulation in a frame may be fixed. The number will typically be determined in accordance with the relevant application;
An aggregation timer. Cells may be collected for a certain time before encapsulation in accordance with the relevant application;
The Ethernet Maximum Transfer Unit (MTU). The cells may be collected into the cell bundle until the maximum payload size is reached which will generally be network dependent.

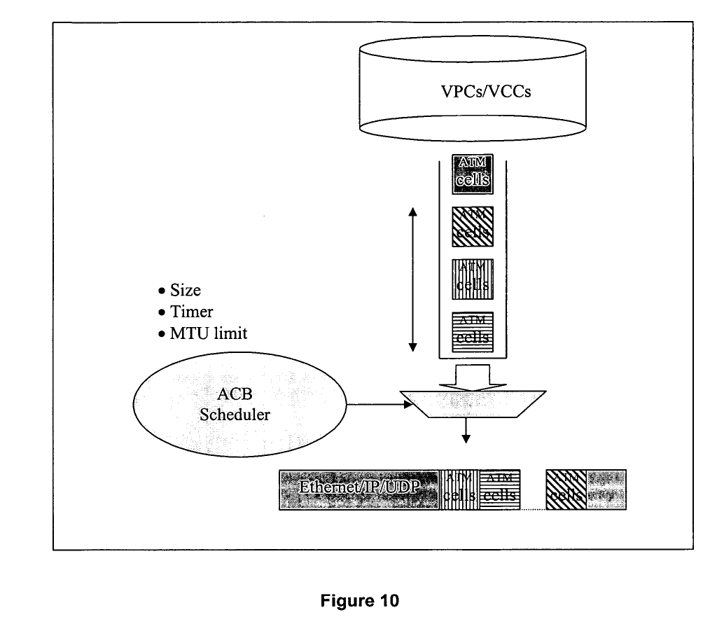

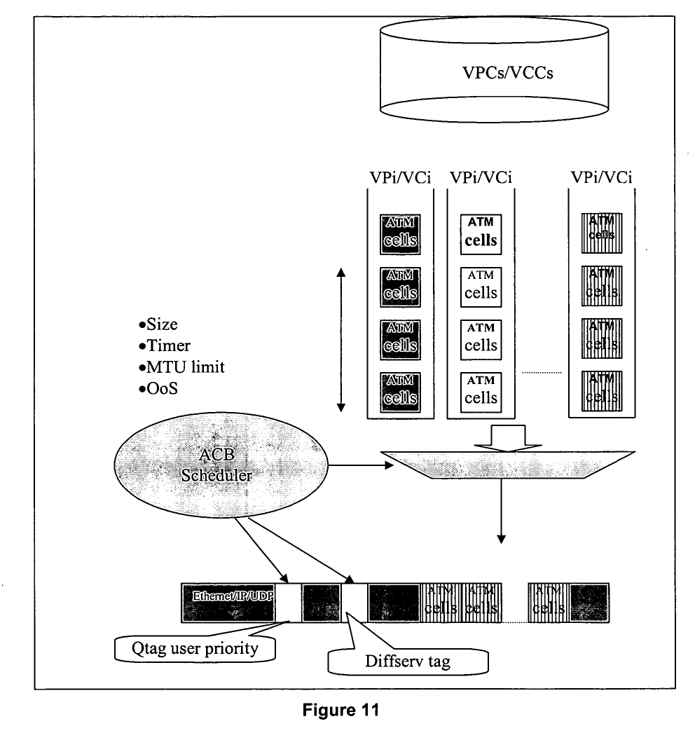

This policy is illustrated on FIG. 10. In this case the Ethernet Qtag field and IP Diffserv DSCP field are kept null.

1.3.2 Addressing Information

In this embodiment, the scheduler maps several ATM cells of the very same virtual path connection or VPC virtual circuit connection VCC (in the ATM network) in each ACB. The number of cells in an Ethernet frame is driven by any of four parameters or any combination of these:
A fixed number of cells. The cells to be encapsulated into a frame may be a fixed number. The number will typically be selected in accordance with the application;
An aggregation timer. Cells may be collected for a certain time before encapsulation, typically dependent on the application;
The Ethernet MTU, The cells may be collected into the bundle until a maximum payload size is reached which will generally be network dependent;
Cells may be selected based on ATM QoS information, e.g. that corresponds to the addressing information in the ATM network. This will typically be the virtual circuit identifier, i.e. of the relevant VPC/VCC.

This policy is illustrated on FIG. 11. In this case the Ethernet Qtag field and IP Diffserv DSCP field are filled with the QoS information that corresponds to the ATM addressing information (e.g. typically the virtual circuit identifier, i.e. VPCNCC) of the cells which fill the ACB, respectively in order to relay the QoS information throughout the encapsulation chain, as described above.

1.3.3 Frame Type

In this embodiment, the scheduler maps several ATM cells of the same ATM segmentation or frame type, i.e. AAL type in each ACB. The AAL type is associated with QoS information. The number of cells in an Ethernet frame is driven by any of four parameters or combination of these:
A fixed number of cells, i.e. the number of cells to be encapsulated in a frame is selected based on a fixed number. The number is typically application dependent;
An aggregation timer, the cells to be encapsulated are selected based on a time period which will typically be application dependent;
The Ethernet MTU. The numbers of cells in a bundle will be limited by a maximum payload which will typically be network dependent;
Frame type. The cells selected all belong to the same frame type, e.g. AAL type: AAL1, AAL2 or AAL5.

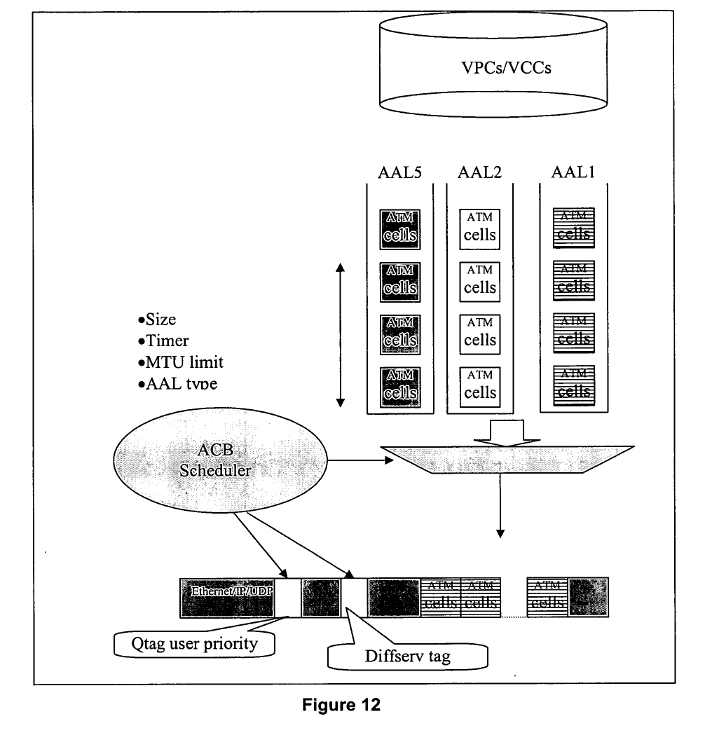

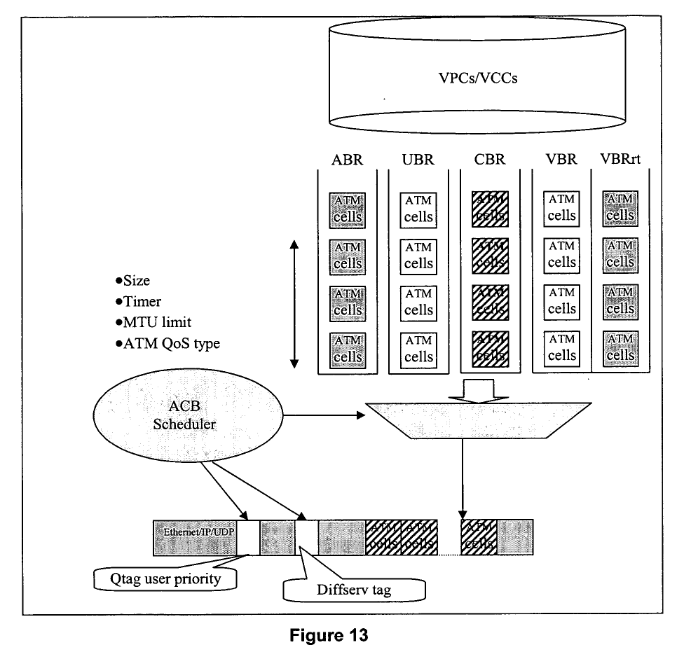

This policy is illustrated on FIG. 12. In this case the Qtag Field and Diffserv field are filled with the QoS information that corresponds to the AAL type of the cells which fill the ACB, respectively.

1.3.4 Quality of Service

In this embodiment, the scheduler maps several ATM cells of the same or a corresponding QoS type in each ACB. In a preferred embodiment, the mapping is performed with respect to ATM QoS classes, the Ethernet Qtag field and, if present, the Diffserv tag. The exact mapping between ATM QoS classes, Qtag user priority field values and Diffserv tag values is defined based on the following principle: a distinct Qtag user priority or Diffserv tag value is used for each matching ATM QoS Class.

The number of cells is driven by any of four parameters or combinations of these:
A fixed number of cells. The number of cells to be encapsulated into a frame is fixed and is typically application dependent;
An aggregation timer. Cells are collected for a period of time and then encapsulated. The elapsed time is typically application dependent;
The Ethernet MTU. The number of cells in one frame is limited by a maximum payload. This is typically network dependent;
The cells selected may all have the same ATM QoS class, e.g. UBR, CBR, VBR, VBRrt.

This policy is illustrated on FIG. 13.

In this case the Qtag Field and Diffserv field are filled with the QoS information that corresponds to the ATM QoS classes of the cells which fill the ACB, respectively.

2. Implementation

The present invention may be implemented in hardware or, for example, in software using a processing engine such as a microprocessor or a programmable logic device (PLD's) such as a PLA (programmable logic array), PAL (programmable array logic), FPGA (field programmable gate array).

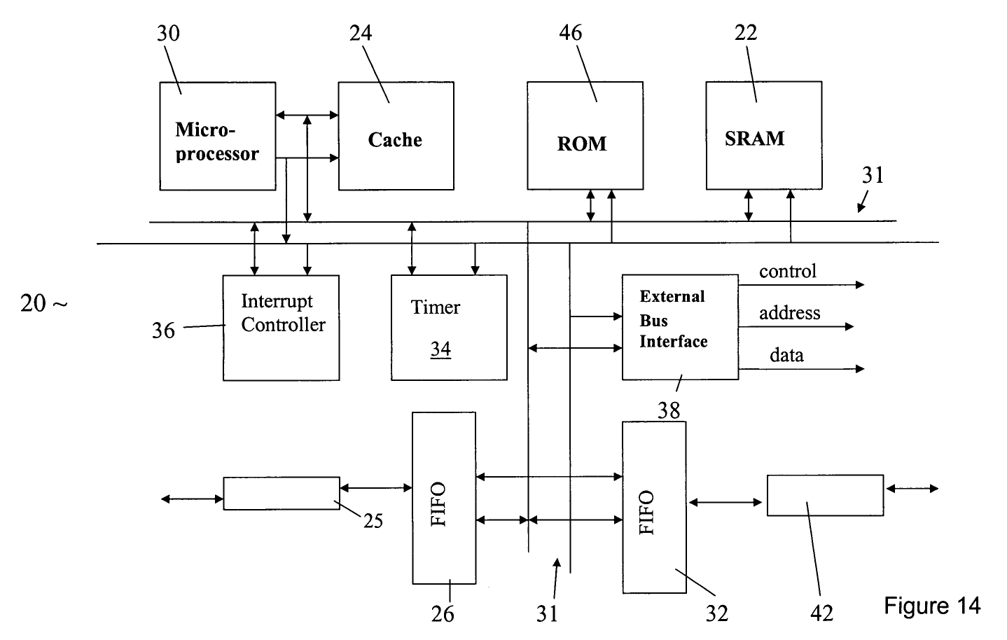

An example of a circuit 20 with an embedded processor will be described with reference to FIG. 14 for use in a base station or a mobile radio telephone receiver/transmitter. This circuit 20 may be constructed as a VLSI chip around an embedded microprocessor 30 such as an ARM7TDMI core designed by ARM Ltd., UK which may be synthesized onto a single chip with the other components shown. Alternatively other suitable processors may be used and these need not be embedded, e.g. a Pentium processor as supplied by Intel Corp. USA. A zero wait state SRAM memory 22 may be provided on-chip as well as a cache memory 24.

I/O (input/output) interfaces 25, 42 are provided for receiving and transmitting data to the relevant networks, e.g. a data or speech information. FIFO buffers 26, 32 may be used to decouple the processor 30 from data transfer through these interfaces. The interfaces 25, 42 provide network connections, i.e. suitable ports and network addresses, e.g. the interfaces may be in the form of network cards. A counter/timer block 34 may be provided as well as an interrupt controller 36. The circuit 20 provides a ATM over Ethernet adaption in accordance with the present invention. The circuit 20 may be provided in a base station or node B of a wireless telecommunications network, for example.

Software programs may be stored in an internal ROM (read only memory) 46 and/or on any other non-volatile memory, e.g. they may be stored in an external memory. Access to an external memory may be provided an external bus interface 38 with address, data and control busses. The various blocks of circuit 20 are linked by suitable busses 31. The methods ands the scheduler of the present invention may be implemented as software to run on processor 30. In particular a scheduler in accordance with the present invention may be implemented by suitable programming of the processor 30. The methods and procedures described above may be written as computer programs in a suitable computer language such as C and then compiled for the specific processor in the embedded design. For example, for the embedded ARM core VLSI described above the software may be written in C and then compiled using the ARM C compiler and the ARM assembler. The software has code, which when executed on a processing engine provides the methods and the scheduler of the present invention. Software code includes code for encapsulating data from a cell and packet based network utilizing a virtual circuit type implementation mechanism and an asynchronous transfer format in a frame of a frame based protocol. The code defines algorithms which include at least two policies for scheduling the encapsulation of the data as well as means for selecting one of the at least two policies for encapsulating the data. One of the policies provided by the software can comprise scheduling data from the cell and packet based network for encapsulation based on: addressing information, or Quality of Service information, or data type information, or virtual channel identifiers. When the policy is based on addressing information, software code includes means for scheduling of data into a frame by one of the following: selecting a fixed number of data cells per frame, selecting data cells based on an elapsed time, selecting data cells to stay within a maximum payload size, or selecting data cells based on QoS information that corresponds to the addressing information.

When the policy is based on a data type of the data or Quality of Service information associated with the data or virtual channel identifiers, the software code includes means for scheduling of data into a frame by one of the following: selecting a fixed number of data cells per frame; selecting data cells based on an elapsed time, or selecting data cells to stay within a maximum payload size. The software code may also have one of the policies having means for directly encapsulating the data cells in a frame of the frame type protocol. The software code may also have means for forming the data cells into cell bundles.

The software code may also include means for encapsulating the data from the cell and packet based network utilizing a virtual circuit type implementation mechanism and an asynchronous transfer format using a connectionless datagram forwarding protocol and then using the frame based protocol. The connectionless datagram protocol may include a transport protocol without an acknowledgement function.

The software code may also have means for populating a header of the connectionless datagram forwarding protocol with QoS information associated with the encapsulated cells. The software code may also have means for populating a header of the frame with which the cells are encapsulated with QoS information associated with these cells.

The software programs may be stored on any suitable machine readable medium such as magnetic disks, diskettes, solid state memory, tape memory, optical disks such as CD-ROM or DVD-ROM, etc.

What is claimed:

1. A method for encapsulating data from a cell and packet based network utilizing a virtual circuit type implementation mechanism and an asynchronous transfer format in a frame of a frame based protocol, the method comprising:
providing at least two policies for scheduling the encapsulation of the data, and
selecting one of the at least two policies for encapsulating the data.

2. The method according to claim 1, one of the policies comprises scheduling data from the cell and packet based network for encapsulation based on:
addressing information, or
Quality of Service information, or
data type information, or
virtual channel identifiers.

3. The method of claim 2 wherein the policy is based on addressing information, and the scheduling of data into a frame includes one of: selecting a fixed number of data cells per frame, selecting data cells based on an elapsed time, selecting data cells to stay within a maximum payload size, or selecting data cells based on QoS information that corresponds to the addressing information.

4. The method of claim 2 wherein the policy is based on a data type of the data or Quality of Service information associated with the data or virtual channel identifiers and the scheduling of data into a frame includes one of:
selecting a fixed number of data cells per frame; selecting data cells based on an elapsed time, or selecting data cells to stay within a maximum payload size.

5. The method according to claim 1 wherein one of the policies is directly encapsulating the data cells in a frame of the frame type protocol.

6. The method according to claim 1, wherein one of the policies includes forming the data cells into cell bundles.

7. The method according to claim 1, wherein the data from the cell and packet based network utilizing a virtual circuit type implementation mechanism and an asynchronous transfer format is encapsulated using a connectionless datagram forwarding protocol and then using the frame based protocol.

8. The method according to claim 7, wherein the connectionless datagram protocol includes a transport protocol without an acknowledgement function.

9. The method according to claim 7, further comprising populating a header of the connectionless datagram forwarding protocol with QoS information associated with the encapsulated cells.

10. The method according to claim 1 further comprising populating a header of the frame with which the cells are encapsulated with QoS information associated with these cells.

11. A scheduler for encapsulating data from a cell and packet based network utilizing a virtual circuit type implementation mechanism and an asynchronous transfer format into a frame of a frame based protocol, scheduler comprising:
means for providing at least two policies for encapsulating the data and means for selecting one of the at least two policies, and means for scheduling the encapsulation of the data in accordance with the selected policy.

12. The scheduler according to claim 11, wherein the means for providing one of the policies comprises means for scheduling data from the cell and packet based network for encapsulation based on:
addressing information, or
Quality of Service information, or
data type information, or
virtual channel identifiers.

13. The scheduler of claim 12 wherein the means for providing a policy is based on addressing information, and the means for scheduling of data into a frame includes one of: means for selecting a fixed number of cells per frame, means for selecting cells based on an elapsed time, means for selecting cells to stay within a maximum payload size, or means for selecting cells based on QoS information that corresponds to the addressing information.

14. The scheduler of claim 12 wherein the means for providing a policy is based on a data type of the cells or Quality of Service information or virtual channel identifiers and the means for scheduling of the cells into a frame includes one of:
means for selecting a fixed number of cells per frame; means for selecting cells based on an elapsed time, or means for selecting cells to stay within a maximum payload size.

15. The scheduler according to claim 11, the scheduler is adapted to directly encapsulate the cells in a frame of the frame type protocol.

16. The scheduler according to claim 11 wherein the scheduler is adapted to form the cells into cell bundles.

17. The scheduler according to claim 11, wherein scheduler is adapted to encapsulate the data from the cell and packet based network utilizing a virtual circuit type implementation mechanism and an asynchronous transfer format by first encapsulating the cells in a connectionless datagram forwarding protocol and then using the frame based protocol.

18. The scheduler according to claim 11, further comprising means for populating a header of the frame with which the cells are encapsulated with QoS information associated with the cells.

19. A node of a wireless network including the scheduler of claim 11.

20. A computer readable medium having processor executable instructions thereon for implementation by a processor, the instructions being for encapsulating data from a cell and packet based network utilizing a virtual circuit type implementation mechanism and an asynchronous transfer format in a frame of a frame based protocol, the instructions further providing means for providing at least two policies for scheduling the encapsulation of the data, and
means for selecting one of the at least two policies for encapsulating the data.

21. A signal comprising data from a cell and packet based network utilizing a virtual circuit type implementation mechanism and an asynchronous transfer format encapsulated in a frame of a frame based protocol, a header of the frame being populated with QoS information associated with the cells.

22. The signal of claim 21, wherein the data is encapsulated in a connectionless datagram forwarding protocol and then using the frame based protocol, a header of the connectionless datagram forwarding protocol being populated with QoS information associated with the cells.
